(19) United States
(12) Patent Application Publication
(10) Pub. No.: US 2025/0227542 A1
(43) Pub. Date: Jul. 10, 2025

(54) QUALITY OF SERVICE (QOS) DIFFERENTIATION IN USER-PLANE PROCEDURES

(71) Applicant: QUALCOMM Incorporated, San Diego, CA (US)

(72) Inventors: Linhai HE, San Diego, CA (US); Gavin Bernard HORN, La Jolla, CA (US); Miguel GRIOT, La Jolla, CA (US); Ruiming ZHENG, Beijing (CN); Yuchul KIM, San Diego, CA (US); Huilin XU, Temecula, CA (US)

(21) Appl. No.: 18/853,285

(22) PCT Filed: Sep. 15, 2022
(86) PCT No.: PCT/CN2022/118973

§ 371 Date: Oct. 1, 2024

(30) Foreign Application Priority Data
May 25, 2022 (WO) PCT/CN2022/094875

(51) Int. Cl. H04W 28/02

(52) U.S. Cl. CPC H04W 28/0268; H04W 28/0252

(57) ABSTRACT

Certain aspects of the present disclosure provide a method for wireless communications by a user equipment (UE). The UE receives a configuration of at least one quality of service (QoS) profile identifier (QPI) from a network entity. The at least one QPI is associated with a plurality of QoS flows within a data radio bearer (DRB). Each of the plurality of QoS flows is associated with at least one protocol data unit (PDU). The UE performs one or more layer 2 (L2) procedures, based on the received configuration.

### CROSS-REFERENCE TO RELATED APPLICATION

This application claims benefit of and priority to PCT Patent Application No. PCT/CN2022/094875, filed May 25, 2022, which is hereby incorporated by reference in its entirety.

### BACKGROUND

### Field of the Disclosure

Aspects of the present disclosure relate to wireless communications, and more particularly, to techniques for quality of service (QoS) differentiation in user-plane procedures for packet processing.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE), comprising: receiving a configuration of at least one quality of service (QoS) profile identifier (QPI) from a network entity, wherein the at least one QPI is associated with a plurality of QoS flows within a data radio bearer (DRB), and wherein each of the plurality of QoS flows is associated with at least one protocol data unit (PDU); and performing one or more layer 2 (L2) procedures, based on the received configuration.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts example quality of service (QoS) flows for extended reality (XR) applications with different QoS requirements.

FIG. 6 depicts example layer 2 (L2) architecture.

FIG. 7 depicts a call flow diagram illustrating example communication between a UE and a network entity.

FIG. 8 depicts example QoS differentiation for different QoS flows within a data radio bearer (DRB) using a new QoS profile identifier (QPI) associated with the different QoS flows.

FIG. 9 depicts example differentiated L2 procedures within a DRB.

FIG. 10 depicts example inter-QPI out of order delivery to an upper layer.

FIG. 11 depicts a method for wireless communications by a UE.

FIG. 12 depicts aspects of an example communications device.

### DETAILED DESCRIPTION

Aspects of the present disclosure provide apparatuses, methods, processing systems, and computer-readable mediums for quality of service (QoS) differentiation in user-plane layer 2 (L2) procedures for packet processing. The L2 procedures may include a packet data convergence protocol (PDCP) layer procedure, a radio link control (RLC) layer procedure, and/or a medium access control (MAC) layer procedure.

Current L2 procedures are configured and performed on a per data radio bearer (DRB) basis under assumption that all packets in a same DRB have compatible and similar QoS requirements. This makes it difficult for a L2 procedure (e.g., the PDCP layer procedure) to meet different QoS requirements of individual QoS flows multiplexed in the same DRB. For example, when QoS flows associated with control packets and text message packets are multiplexed in the same DRB, during the L2 procedure, a PDCP layer discard timer configured based on a packet delay budget (PDB) of the control packets may cause a high loss for the text message packets. Accordingly, there is a need to differentiate the QoS requirements associated with the different QoS flows within the same DRB, to enable the L2 procedure to meet the different QoS requirements of individual QoS flows multiplexed in the same DRB.

Techniques proposed herein support differentiated user-plane L2 procedures for packet processing within a DRB associated with multiple QoS flows having different QoS requirements, based on a configured QoS profile identifier (QPI) associated with QoS flow(s) within the DRB. The QPI may be associated with one or more QoS flows (e.g., having similar QoS requirements) within the DRB. In one example, the QPI may be associated with two QoS flows. In another example, the QPI may be associated with one QoS flow. The application of the differentiated user-plane L2 procedures (e.g., based on configured QPIs) within the DRB can meet the QoS requirements of individual QoS flows in the same DRB.

For example, when a first set of QoS flows (e.g., one or more QoS flows associated with control packets with a short deadline) configured with a first QPI are multiplexed with a second set of QoS flows (e.g., one or more QoS flows associated with user message packets such as audio/voice/text data) configured with a second QPI in the same DRB, the application of the differentiated user-plane L2 procedures within the DRB corresponds to selection of a first value of a discard timer for the first set of QoS flows (e.g., based on the configured first QPI) and a second value of the discard timer for the second set of QoS flows (e.g., based on the configured second QPI). The first value and the second value are selected to meet the QoS requirements of the first set of QoS flows and the second set of QoS flows within the same DRB.

The techniques proposed herein can provide high speed/throughput, high reliability, and low latency by meeting the different QoS requirements of the individual QoS flows multiplexed in the same DRB.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

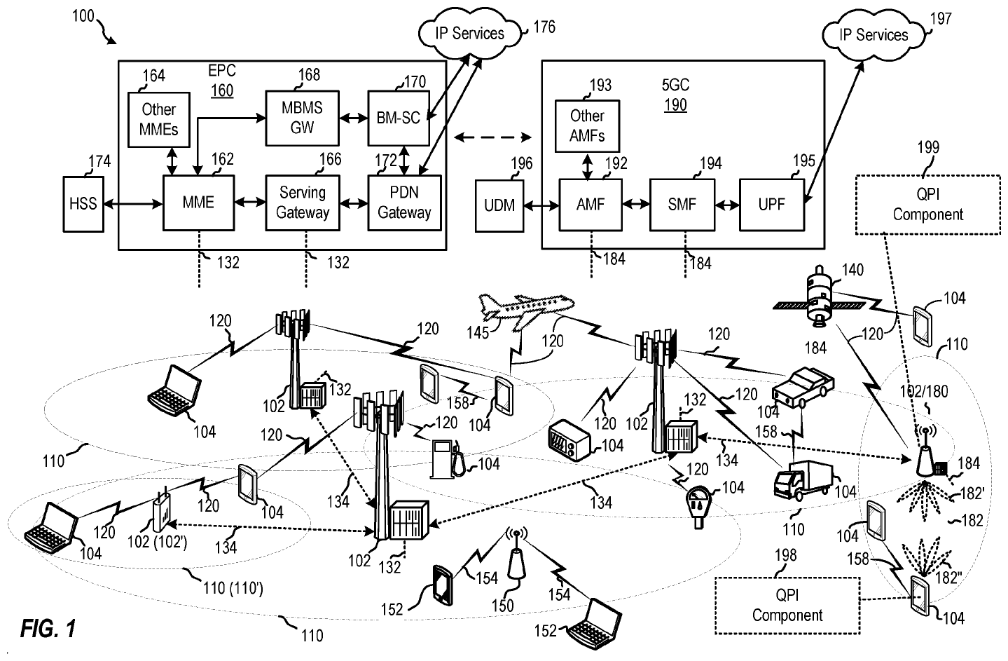

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

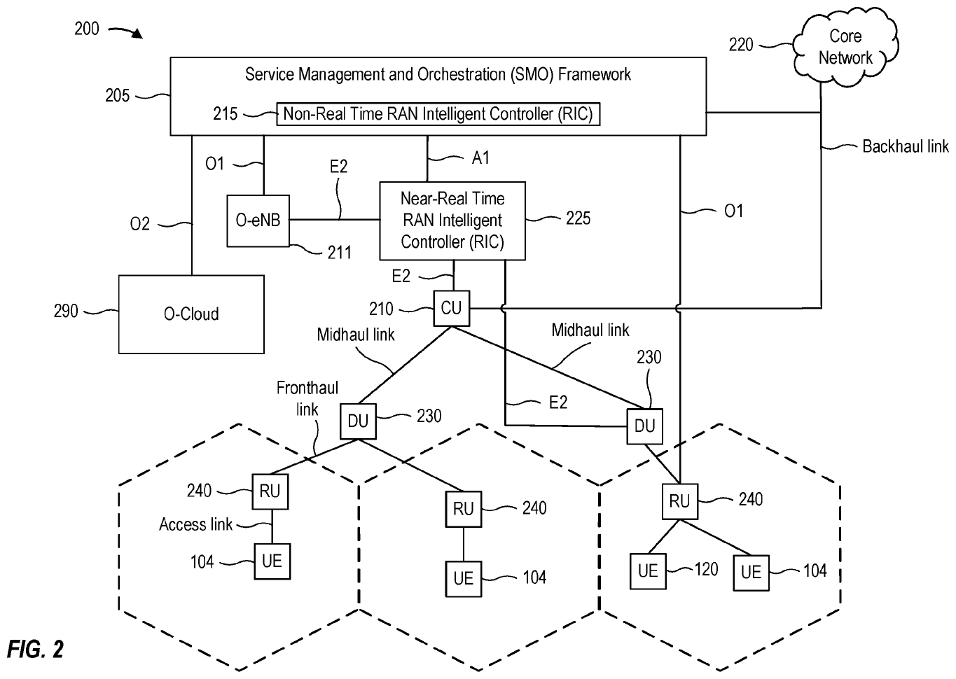

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′ BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

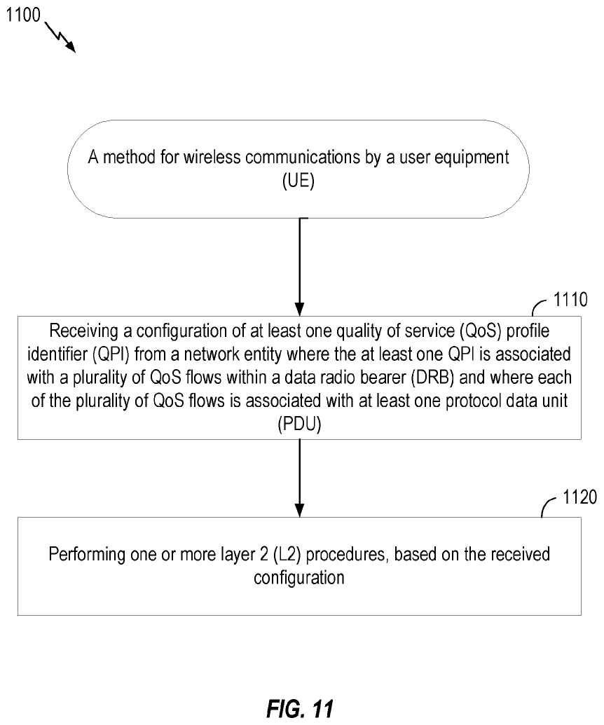

Wireless communication network 100 further includes quality of service (QoS) profile identifier (QPI) component 198, which may be configured to perform operations 1100 of FIG. 11. Wireless communication network 100 further includes QPI component 199.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

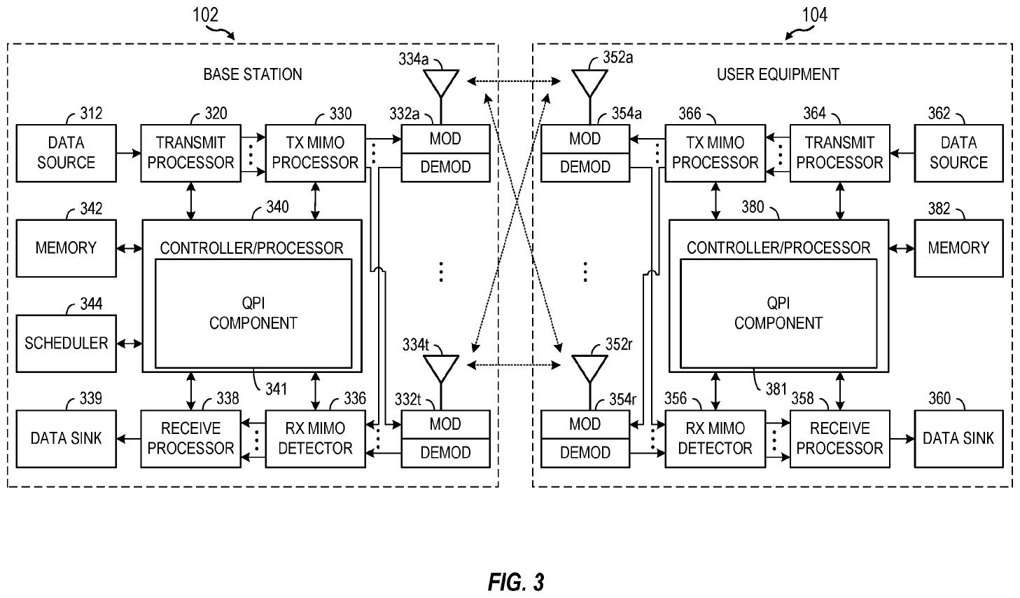

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes QPI component 341, which may be representative of QPI component 199 of FIG. 1. Notably, while depicted as an aspect of controller/processor 340, QPI component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes QPI component 381, which may be representative of QPI component 198 of FIG. 1. Notably, while depicted as an aspect of controller/processor 380, QPI component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

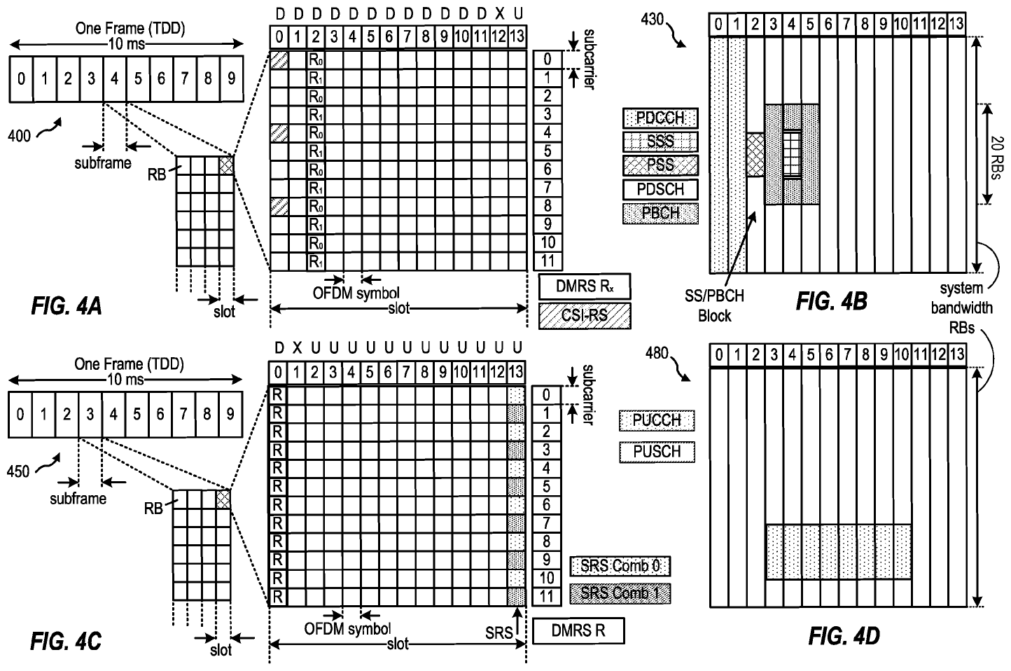

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Quality of Service (QoS)

Quality of service (QoS) refers to a measurement of overall performance of a service experienced by users of a network. To quantitatively measure QoS packet loss, bit rate, throughput, transmission delay, availability, etc. related aspects of the service are considered. QoS includes requirements on all aspects of a connection, such as service response time, loss, signal-to-noise ratio, crosstalk, echo, interrupts, frequency response, and/or loudness levels.

In 5G new radio (NR), QoS is enforced at a QoS flow level. Each QoS flow packets (e.g., data packets) are classified and marked using QoS flow identifier (QFI). For example, a first QoS flow is associated with video packets (e.g., the video packets of a first video conference company and the video packets of a second video conference company) and a second QoS flow is associated with video streaming packets (e.g., the video packets of a first video stream company). The one or more QoS flows are mapped in an access network to one or more data radio bearers (DRBs). For example, a DRB transports packets of an evolved packet system (EPS) bearer between a user equipment (UE) and a network entity.

Within the 5G network, 5G QoS identifier (5QI) mechanism may be used in which packets are classified into different QoS classes. In this way, the QoS can be tailored to specific requirements. Each QoS class has its own assigned QoS characteristics (e.g., such as packet delay and packet loss). Accordingly, some packets can get better QoS than other packets.

The network entity maps individual QoS flows to one or more DRBs. A protocol data unit (PDU) session may contain multiple QoS flows and several DRBs. For example, the PDU session provides end-to-end user-plane connectivity between the UE and a specific data network through user-plane function (UPF). The PDU session supports one or more QoS flows, and a DRB transports the one or more QoS flows.

The network entity provides the UE with one or more QoS flow descriptions associated with the PDU session at the PDU session establishment or at the PDU session modification. Each QoS flow description may include a) a QFI; b) if the QoS flow is a guaranteed bit rate (GBR) QoS flow: 1) guaranteed flow bit rate (GFBR) for uplink, 2) GFBR for downlink, 3) maximum flow bit rate (MFBR) for uplink, 4) MFBR for downlink and/or 5) averaging window applicable for both uplink and downlink, or if the QoS flow is a non-GBR QoS flow: 1) reflective QoS attribute (RQA) in downlink and/or 2) additional QoS flow information; c) 5G QoS identifier (5QI) if the QFI is not the same as the 5QI of the QoS flow identified by the QFI; d) allocation and retention priority (ARP), and/or e) an EPS bearer identity (EBI) if the QoS flow can be mapped to an EPS bearer. All packets belonging to a specific QoS flow has a same 5QI.

The network entity provides the UE with QoS rules associated with the PDU session. The QoS rules may be provided at the PDU session establishment or at the PDU session modification. Each QoS rule includes an indication of whether the QoS rule is a default QoS rule, a QoS rule identifier (QRI), a QFI, a set of packet filters, and/or a precedence value.

### Example Quality of Service (QoS) Flows in Extended Reality (XR) Applications

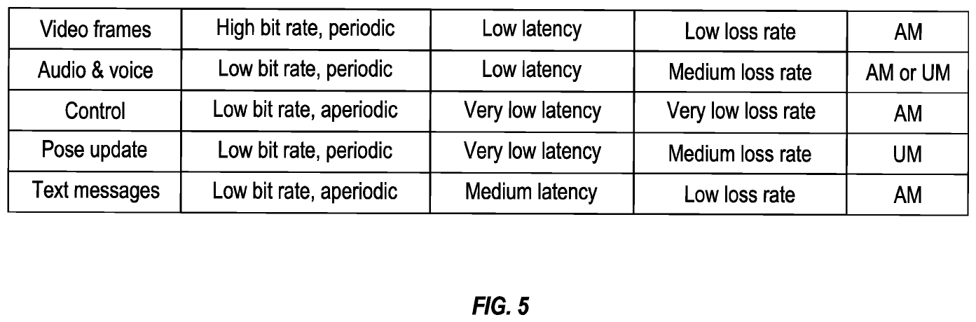

An extended reality (XR) application may include a virtual reality (VR) application, an augmented reality (AR) application, and/or a mixed reality (MR) application. The XR application generates multiple quality of service (QoS) flows for different packets. As illustrated in FIG. 5, the multiple QoS flows are associated with video frame packets, audio/voice packets, control packets (e.g., a user equipment (UE) may send multiple control messages during a car video game), pose update packets (e.g., user head movement in a VR game), and text message packets. As further illustrated in FIG. 5, the multiple QoS flows may have different QoS requirements (e.g., latency requirements, loss rate requirements, bit rate requirements etc.).

Ideally, each QoS flow should be mapped to a single data radio bearer (DRB). However, in most cases, multiple QoS flows are mapped to the single DRB. The mapping of the multiple QoS flows to the single DRB may happen due to several reasons. In one example (i.e., on network entity side), an operator is charged (e.g., operating costs) based on a number of DRBs. Accordingly, to prevent high charges, the operator may multiplex the multiple QoS flows into the single DRB (e.g., as long as QoS requirements of all the QoS flows being multiplexed into the single DRB can be met). In another example (e.g., on UE side), each DRB requires a separate layer 2 (L2) entity and a block of dedicated memory. Accordingly, the multiple DRBs will require a large memory in the UE. The use of the large memory results in a higher production cost of the UE as well as more power consumption by the UE during operation.

In some cases (e.g., XR applications), when the multiple QoS flows are mapped to the single DRB, the multiple QoS flows may have similar but somewhat different QoS requirements. For example, when the multiple QoS flows associated with the audio/voice packets and the pose update packets are mapped to the single DRB due to their similar QoS requirements (e.g., lower bit rate requirements), the pose update packets will still require better QoS treatment than the audio/voice packets (e.g., due to very low latency QoS requirement associated with the pose update packets).

Currently, it is not possible to provide the better QoS treatment to the pose update packets than the audio/voice packets during processing, since there is no technique to differentiate the QoS requirements associated with the multiple QoS flows within the single DRB. Accordingly, there is a need to differentiate the QoS requirements associated with the multiple QoS flows within the single DRB, to provide the better QoS treatment to one QoS flow (e.g., related to the pose update packets) over other QoS flow (e.g., related to audio/voice packets) on the basis of their different QoS requirements.

In some cases, UEs for XR applications may be reduced capabilities (RedCap) UEs, which have a smaller memory and are more power sensitive. A RedCap UE may exhibit a relaxation of peak throughput (e.g., 20 MHz), as well as lower latency and/or reliability requirements. Also, the RedCap UE may involve lower device cost (and complexity) and improved efficiency (e.g. power consumption, system overhead, and cost improvements) as compared to high-end devices, such as high-end enhanced mobile broadband (eMBB) and ultra-reliable low latency communication (URLLC) devices of 5G NR Rel-15/16 (e.g., high-end smartphones). Some design objectives of an NR RedCap UE may include scalable resource allocation, coverage enhancement for downlink and/or uplink, power saving in all radio resource control (RRC) states, and/or co-existence with the NR premium UE. As The NR-RedCap UE may be a smart wearable device, a sensor (e.g., industrial wireless sensor networks), a camera (e.g., a surveillance camera), a low-end smartphone, or any other device configured for relaxed internet-of-things (IoT) communications.

### Example Layer 2 (L2) of New Radio (NR) Protocol Stock

New radio (NR) radio protocol stack has two categories: 1) control-plane stack, and 2) user-plane stack. If data corresponds to signaling or controlling message, then the data is sent through the control-plane. User data is sent through the user-plane.

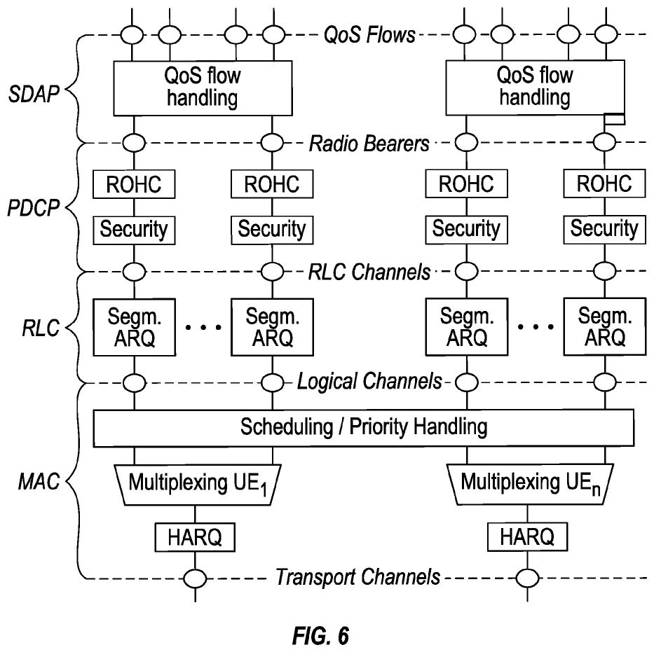

As illustrated in FIG. 6, user-plane protocol stock (e.g., layer 2 (L2)) of NR is split into sub layers such as a service data adaptation protocol (SDAP) layer, a packet data convergence protocol (PDCP) layer, a radio link control (RLC) layer, and a medium access control (MAC) layer. In NR, carrier aggregation is supported, and data for each carrier may be processed independently in the SDAP layer, the PDCP layer, the RLC layer and is multiplexed in the MAC layer.

The SDAP layer may perform mapping between a quality of service (QoS) flow (e.g., associated with one or more packets (e.g., protocol data units (PDUs)) and a data radio bearer (DRB) (e.g., due to QoS framework). The SDAP layer may also perform marking QoS flow ID (QFI) in both downlink and uplink packets (e.g., downlink due to reflective QoS and uplink due to QoS framework). A single protocol entity of SDAP is configured for each individual protocol data unit (PDU) session.

The PDCP layer may perform header compression and decompression of internet protocol (IP) data (e.g., robust header compression (ROHC)), maintain PDCP sequence numbers (SNs), perform in-sequence delivery of upper layer PDUs at re-establishment of lower layers, perform reordering and eliminate duplicates of lower layer service data units (SDUs), execute PDCP PDU routing for the case of split bearers, execute retransmission of lower layer SDUs, cipher and decipher control plane and user-plane data, perform integrity protection and integrity verification of control plane and user plane data, control timer-based discard of data, and perform security operations (e.g., ciphering, deciphering, integrity protection, integrity verification, etc.).

The RLC layer may operate in a plurality of modes of operation including transparent mode (TM), unacknowledged mode (UM), and acknowledged mode (AM). The RLC layer may perform transfer of upper layer PDUs error correction through automatic repeat request (ARQ) for AM data transfers, and segmentation and reassembly of RLC SDUs for UM and AM data transfers. The RLC layer may maintain SNs independent of the ones in PDCP for UM and AM data transfers. The RLC layer may perform resegmentation of RLC data PDUs for AM data transfers, detect duplicate data for AM data transfers, discard RLC SDUs for UM and AM data transfers, detect protocol errors for AM data transfers, and/or perform RLC re-establishment.

The MAC layer may perform mapping between logical channels and transport channels, multiplexing of MAC SDUs from one or more logical channels onto transport blocks (TB) to be delivered to a physical layer (PHY) via transport channels, de-multiplexing MAC SDUs to one or more logical channels from TB delivered from the PHY via the transport channels, scheduling information reporting, error correction through hybrid automatic repeat request (HARQ), priority handling between UEs by means of dynamic scheduling, priority handling between logical channels of one UE by means of logical channel prioritization, and/or padding.

Current L2 procedures (e.g., PDCP layer procedures, MAC layer procedures, etc.) are configured and performed on a per-DRB basis (e.g., under assumption that all packets in a same DRB have compatible and similar QoS requirements). This makes it difficult for a L2 procedure to meet different QoS requirements of individual QoS flows multiplexed in the same DRB. In one example, when QoS flows associated with control packets and text message packets are multiplexed in the same DRB, a PDCP discard timer (e.g., a short discard timer) configured based on a packet delay budget (PDB) of the control packets may cause a high loss for the text message packets during the L2 procedure. In another example (e.g., out of order delivery in PDCP), when the QoS flows associated with the control packets and the text message packets are multiplexed in the same DRB, then in some circumstances the text message packets may block a delivery of the control packets (e.g., which may be more latency-sensitive than the text message packets) during the L2 procedure. In another example (e.g., a logical channel prioritization (LCP) in MAC during the L2 procedure), it is more resource efficient to enforce LCP traffic regulator per QoS flow than per DRB.

Accordingly, there is a need to differentiate the QoS requirements associated with the different QoS flows within the same DRB, to enable the L2 procedure to meet the different QoS requirements of individual QoS flows multiplexed in the same DRB.

### Aspects Related to Quality of Service (QoS) Differentiation in User-Plane Procedures

Aspects of the present disclosure provide apparatuses, methods, processing systems, and computer-readable mediums for quality of service (QoS) differentiation in user-plane layer 2 (L2) procedures for packet processing.

Techniques proposed herein support differentiated user-plane L2 procedures for packet processing within a data radio bearer (DRB) associated with multiple QoS flows having different QoS requirements, based on a configured QoS profile identifier (QPI) associated with QoS flow(s) within the DRB (e.g., rather than a QoS flow identifier (QFI) associated with a single QoS flow). The QPI may be associated with one or more QoS flows within the DRB. In one example, the QPI may be associated with two QoS flows (e.g., having similar QoS requirements). In another example, the QPI may be associated with one QoS flow. The application of the differentiated user-plane L2 procedures within the DRB can meet the QoS requirements of individual QoS flows in the same DRB.

For example, when a first set of QoS flows (e.g., one or more QoS flows associated with control packets with a short deadline) configured with a first QPI are multiplexed with a second set of QoS flows (e.g., one or more QoS flows associated with user message packets such as audio/voice/text data) configured with a second QPI in the same DRB, the application of the differentiated user-plane L2 procedures within the DRB corresponds to selection of a first value of a discard timer for the first set of QoS flows (e.g., based on the configured first QPI) and a second value of the discard timer for the second set of QoS flows (e.g., based on the configured second QPI). The first value and the second value are selected to meet the QoS requirements of the first set of QoS flows and the second set of QoS flows within the same DRB.

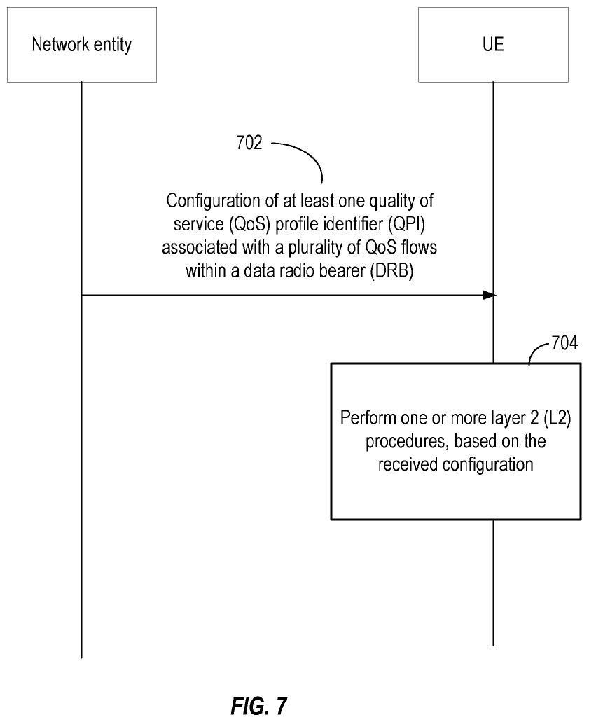

The techniques for the QoS differentiation in the user-plane procedures proposed herein may be understood with reference to the FIGS. 7-11.

As illustrated in FIG. 7, at 702, a network entity (e.g., such as BS 102 in wireless communication network 100 of FIG. 1) transmits a configuration of at least one QPI associated with a plurality of QoS flows (e.g., associated with a plurality of packets (e.g., protocol data units (PDUs)) within a DRB to a UE (e.g., such as UE 104 in wireless communication network 100 of FIG. 1). For example, the network entity may radio resource control (RRC) configure the UE specifying how the plurality of QoS flows are mapped to the at least one QPI.

In some cases, each QoS flow of the plurality of QoS flows may have a unique identifier (e.g., QoS flow identifier (QFI)). The mapping may be one-to-one mapping between the QFI and the at least one QPI (e.g., one QFI is mapped to one QPI). The mapping may be multi-to-one mapping between the QFI and the at least one QPI (e.g., two QFIs are mapped to one QPI). In one example, the mapping may be performed at a service data adaption protocol (SDAP) layer. In another example, the mapping may be performed at some other layer.

At 704, the UE performs one or more L2 procedures based on the received configuration. For example, the UE may support and perform the differentiated L2 procedures or configurations within the DRB based on the configured at least one QPI associated with the PDUs within the DRB.

In certain aspects, the one or more differentiated L2 procedures may include a packet data convergence protocol (PDCP) layer procedure, a radio link control (RLC) layer procedure, and/or a medium access control (MAC) layer procedure that can be differentiated within the DRB (e.g., to meet different QoS requirements of different QoS flows).

In certain aspects, conventional L2 configurations and procedures may apply to all PDUs within the DRB by default. However, the PDUs within the DRB whose QPI match the at least one QPI configured by the RRC may be applicable for the differentiated L2 procedures.

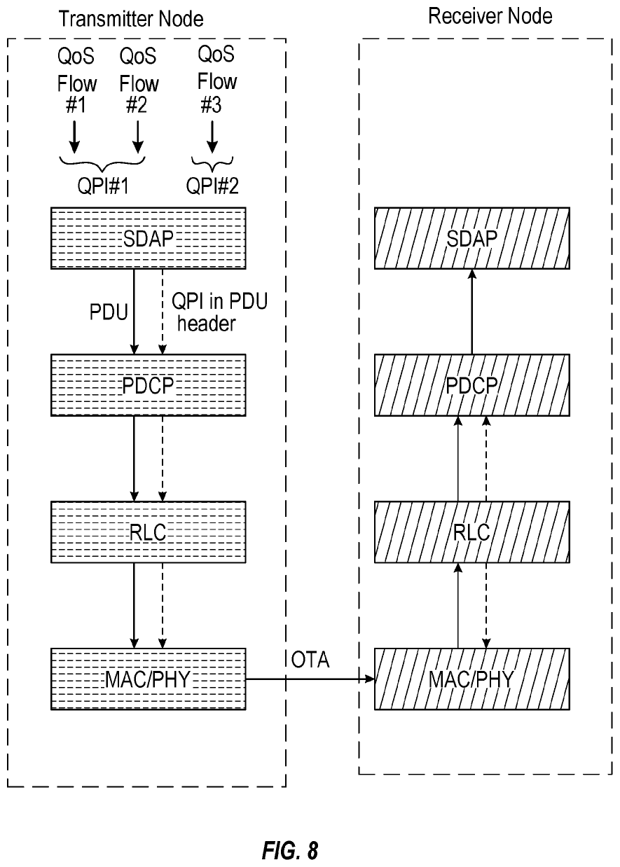

As illustrated in FIG. 8, on a transmitter node (e.g., UE, network entity, etc.), a mapping between different QoS flows and QPIs is performed at a SDAP layer. A QPI of a MAC service data unit (SDU) is then added to a MAC subheader before the QPI is delivered to a physical (PHY) layer. Packets received by a layer are called the SDU. On a receiver node (e.g., network entity, UE, etc.), the QPI is extracted at a MAC layer and the QPI is then passed up L2 protocol stack (e.g., to PDCP layer) by a cross-layer indication.

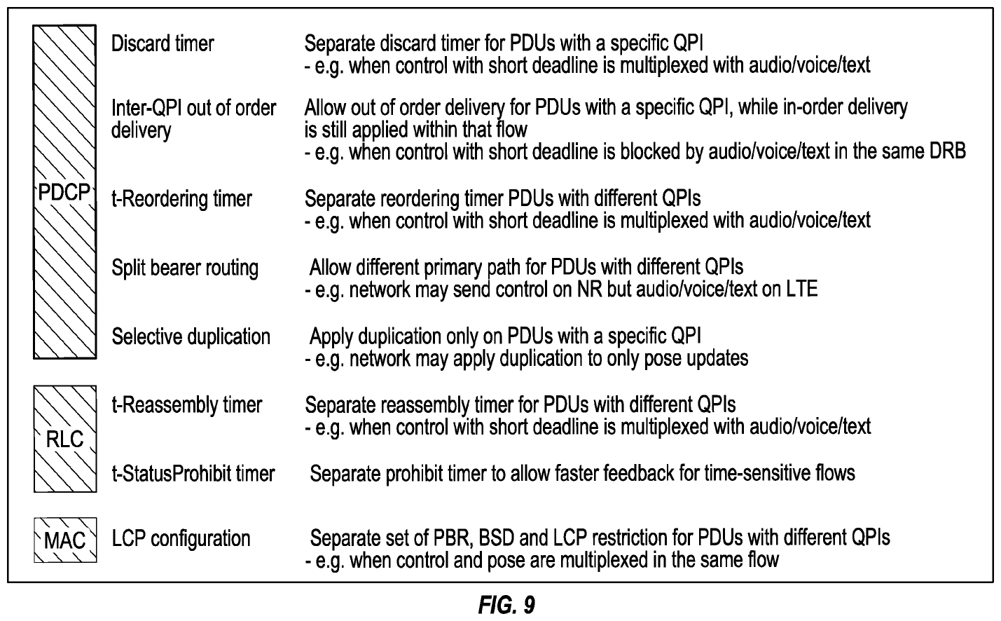

As illustrated in FIG. 9, a UE applies differentiated PDCP procedures, RLC procedures, and MAC procedures on different QoS flows or PDUs associated with different QPIs (e.g., indicating different QoS requirements) within a DRB to meet the different QoS requirements. The differentiated PDCP procedures, RLC procedures, and MAC procedures are based on the different QPIs.

In one example, the UE applies the differentiated PDCP procedures to use separate values for discard timers for the different PDUs associated with the different QPIs. For example, when a first PDU (e.g., a control packet with a short deadline) associated with a first QPI is multiplexed with a second PDU (e.g., a user message packet such as audio/voice/text data) associated with a second QPI, the discard timers for the first PDU and the second PDU may have different values. The different values are selected to meet different QoS requirements of the first PDU and the second PDU.

In another example, the UE applies the differentiated PDCP procedures to allow out of order delivery for the different PDUs associated with the different QPIs, while applying in-order delivery for other PDUs associated with the same QPI. For example, when the first PDU is being blocked by the second PDU within the DRB, the first PDU may be allowed the out of order delivery (e.g., due to the shorter deadline of the first PDU).

In another example, the UE applies the differentiated PDCP procedures to use separate values for reordering timers (e.g., t-Reordering timers) for the different PDUs associated with the different QPIs. For example, the reordering timers for the first PDU and the second PDU may have different values, such that a value of the reordering timer for the first PDU may have a smaller value than a value of the reordering timer for the second PDU. The different values are selected to meet different QoS requirements of the first PDU and the second PDU.

In another example, the UE applies the differentiated PDCP procedures to use different primary paths for the different PDUs associated with the different QPIs (e.g., split bearer routing). For example, the first PDU is sent on new radio (NR) and the second PDU is sent on long term evolution (LTE). The different paths are selected to meet different QoS requirements of the first PDU and the second PDU.

In another example, the UE applies the differentiated PDCP procedures to duplicate one or more PDUs associated with the at least one QPI (e.g., which may be a specific QPI). For example, the UE may only duplicate the first PDU but not the second PDU.

In another example, the UE applies the differentiated RLC procedures to use separate values for reassembly timers (e.g., t-Reassembly timers) for the different PDUs associated with the different QPIs. For example, the reassembly timers for the first PDU and the second PDU may have different values, such that a value of the reassembly timer for the first PDU may have a smaller value than a value of the reassembly timer for the second PDU. The different values are selected to meet different QoS requirements of the first PDU and the second PDU.

In another example, the UE applies the differentiated RLC procedures to use separate values for status prohibit timers (e.g., t-StatusProhibit timers) for the different PDUs associated with the different QPIs. For example, the status prohibit timers for the first PDU and the second PDU may have different values, such that a value of the status prohibit timer for the first PDU may have a smaller value than a value of the status prohibit timer for the second PDU (e.g., to allow faster feedback for time-sensitive PDUs).

In another example, the UE applies the differentiated MAC procedures to perform a separate set of prioritized bit rate (PBR), bucket size duration (BSD) and/or logical channel prioritization (LCP) restrictions for the different PDUs associated with the different QPIs. For example, the PBR/BSD/LCR restrictions for the first PDU associated with the first QPI and a third PDU (e.g., a pose update packet) associated with a third QPI may be different. The different PBR/BSD/LCR restrictions are selected to meet different QoS requirements of the first PDU and the second PDU.

In certain aspects, the configuration corresponds to a first configuration enabling an individual differentiated L2 procedure on top of at least one of default: PDCP configuration, RLC configuration, or logical channel configuration. For example, the network entity may enable differentiation for an individual feature (e.g., a discard timer or a t-statusProhibitTimer) on top of the default PDCP configuration (e.g., PDCP-Config), the default RLC configuration (e.g., RLC-Config) or the default logical channel configuration (e.g., LogicalChannelConfig).

In certain aspects, the configuration corresponds to a second configuration indicating a separate default PDCP configuration, an RLC configuration, or a logical channel configuration for the at least one QPI. For example, the network entity may configure the UE with the PDCP configuration, the RLC configuration, or the logical channel configuration for a specific QPI.

In certain aspects, the configuration indicates applying the first configuration and the second configuration to different protocol stock layers.

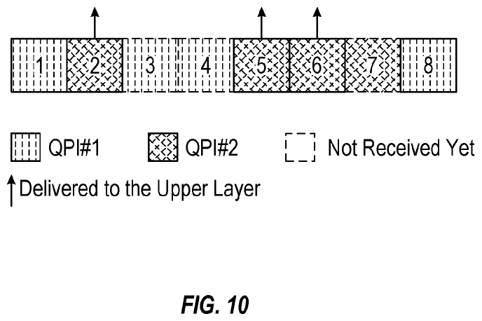

As illustrated in FIG. 10, a first PDU, a third PDU, a fourth PDU, and an eight PDU are associated with a first QPI. A second PDU, a fifth PDU, a sixth PDU, and a seventh PDU are associated with a second QPI. During L2 procedure inter-QPI out of order delivery operation, the first PDU, second PDU, the fifth PDU, the sixth PDU, and the eight PDU are received in a receiver buffer. At this time, the third PDU, the fourth PDU, and the seventh PDU have yet not been received. Since the second PDU, the fifth PDU, and the sixth PDU are in a sequence (and associated with a same QPI), the second PDU, the fifth PDU, and the sixth PDU can be delivered (i.e., inter-QPI out of order delivery) to an upper layer even when the third PDU and the fourth PDU are not received in the buffer. This allows PDUs in a more delay sensitive QoS flow not to be blocked by other PDUs in front of them. In certain aspects, when the inter-QPI out of order delivery is configured, each QPI has its own associated sequence numbers, in addition to a legacy PDCP sequence number.

### Example Operations of a UE

FIG. 11 illustrates example operations 1100 for wireless communication. The operations 1100 may be performed, for example, by a user equipment (UE) (e.g., such as UE 104 in wireless communication network 100 of FIG. 1). The operations 1100 may be implemented as software components that are executed and run on one or more processors (e.g., controller/processor 380 of FIG. 3). Further, transmission and reception of signals by the UE in the operations 1100 may be enabled, for example, by one or more antennas (e.g., antennas 352 of FIG. 3). In certain aspects, the transmission and/or reception of signals by the UE may be implemented via a bus interface of one or more processors (e.g., the controller/processor 380) obtaining and/or outputting signals.

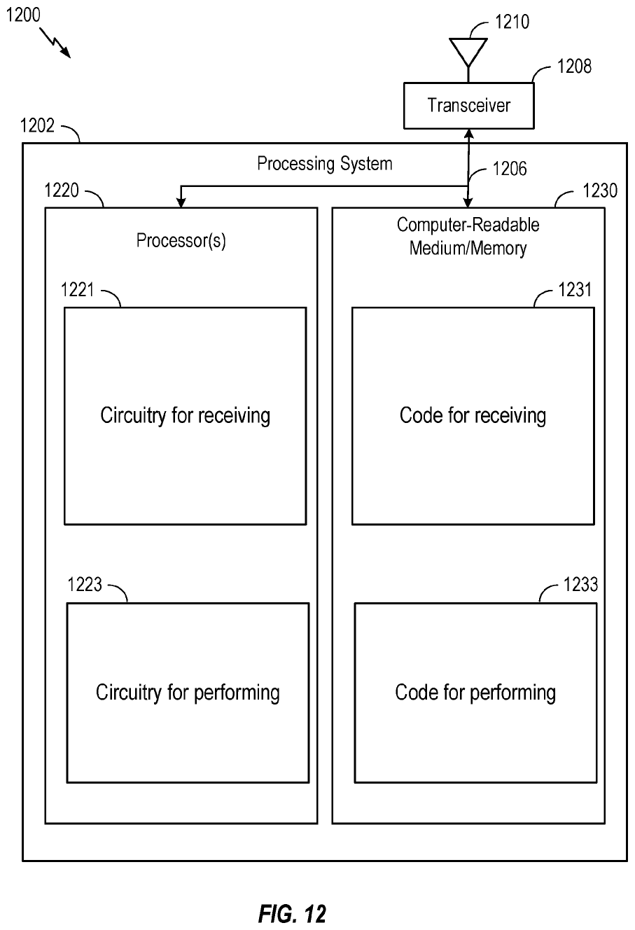

The operations 1100 begin, at 1110, by receiving a configuration of at least one quality of service (QoS) profile identifier (QPI) from a network entity. The at least one QPI is associated with a plurality of QoS flows within a data radio bearer (DRB). Each of the plurality of QoS flows is associated with at least one protocol data unit (PDU). For example, the UE may receive the configuration from the network entity, using antenna(s) and/or receiver/transceiver components of UE 104 shown in FIG. 1 or FIG. 3 and/or of the apparatus shown in FIG. 12.

At 1120, the UE performs one or more layer 2 (L2) procedures, based on the received configuration. For example, the UE may perform the one or more L2 procedures, using a processor of UE 104 shown in FIG. 1 or FIG. 3 and/or of the apparatus shown in FIG. 12.

Note that FIG. 11 is just one example of a method, and other methods including fewer, additional, or alternative steps are possible consistent with this disclosure.

### Example Communications Device

FIG. 12 depicts aspects of an example communications device 1200. In some aspects, communications device 1200 is a user equipment (UE), such as UE 104 described above with respect to FIGS. 1 and 3.

The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes one or more processors 1220. In various aspects, the one or more processors 1220 may be representative of one or more of receive processor 358, transmit processor 364, TX MIMO processor 366, and/or controller/processor 380, as described with respect to FIG. 3. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the operations 1100 described with respect to FIG. 11, or any aspect related to it. Note that reference to a processor performing a function of communications device 1200 may include one or more processors performing that function of communications device 1200.

In the depicted example, computer-readable medium/memory 1230 stores code (e.g., executable instructions) for receiving 1231 comprising code for receiving a configuration of at least one quality of service (QoS) profile identifier (QPI) from a network entity where the at least one QPI is associated with a plurality of QoS flows within a data radio bearer (DRB) and where each of the plurality of QoS flows is associated with at least one protocol data unit (PDU), and code for performing 1233 comprising code for performing one or more layer 2 (L2) procedures, based on the received configuration. Processing of the code 1231-1233 may cause the communications device 1200 to perform the operations 1100 described with respect to FIG. 11, or any aspect related to it.

The one or more processors 1220 include circuitry configured to implement (e.g., execute) the code stored in the computer-readable medium/memory 1230, including circuitry for receiving 1221 comprising circuitry for receiving a configuration of at least one QPI from a network entity where the at least one QPI is associated with a plurality of QoS flows within a DRB and where each of the plurality of QoS flows is associated with at least one PDU and circuitry for performing 1223 comprising circuitry for performing one or more L2 procedures, based on the received configuration. Processing with circuitry 1221-1223 may cause the communications device 1200 to perform the operations 1100 described with respect to FIG. 11, or any aspect related to it.

Various components of the communications device 1200 may provide means for performing the operations 1100 described with respect to FIG. 11, or any aspect related to it. For example, means for transmitting, sending or outputting for transmission may include the transceivers 354 and/or antenna(s) 352 of the UE 104 illustrated in FIG. 3 and/or transceiver 1208 and antenna 1210 of the communications device 1200 in FIG. 12. Means for receiving or obtaining may include the transceivers 354 and/or antenna(s) 352 of the UE 104 illustrated in FIG. 3 and/or transceiver 1208 and antenna 1210 of the communications device 1200 in FIG. 12.

### Example Clauses

Implementation examples are described in the following numbered clauses:

Clause 1: A method for wireless communications by a user equipment (UE), comprising: receiving a configuration of at least one quality of service (QoS) profile identifier (QPI) from a network entity, wherein the at least one QPI is associated with a plurality of QoS flows within a data radio bearer (DRB), and wherein each of the plurality of QoS flows is associated with at least one protocol data unit (PDU); and performing one or more layer 2 (L2) procedures, based on the received configuration.

Clause 2: The method alone or in combination with the first clause, wherein the configuration further indicates a mapping of one or more of the plurality of QoS flows within the DRB to the at least one QPI.

Clause 3: The method alone or in combination with the second clause, wherein the mapping is performed at a service data adaption protocol (SDAP) layer.

Clause 4: The method alone or in combination with the first clause, wherein the performing further comprises using separate discard timers for different PDUs associated with different QPIs.

Clause 5: The method alone or in combination with the first clause, wherein the performing further comprises allowing out of order delivery for different PDUs associated with different QPIs while applying in-order delivery for other PDUs associated with a same QPI.

Clause 6: The method alone or in combination with the first clause, wherein the performing further comprises using separate reordering timers for different PDUs associated with different QPIs.

Clause 7: The method alone or in combination with the first clause, wherein the performing further comprises allowing different primary paths for different PDUs associated with different QPIs.

Clause 8: The method alone or in combination with the first clause, wherein the performing further comprises applying duplication only on one or more PDUs associated with the at least one QPI.

Clause 9: The method alone or in combination with the first clause, wherein the performing further comprises using separate reassembly timers for different PDUs associated with different QPIs.

Clause 10: The method alone or in combination with the first clause, wherein the performing further comprises using separate status prohibit timers for different PDUs associated with different QPIs.

Clause 11: The method alone or in combination with the first cause, wherein the performing further comprises performing a separate set of prioritized bit rate (PBR), bucket size duration (BSD) and logical channel prioritization (LCP) restrictions for different PDUs associated with different QPIs.

Clause 12: The method alone or in combination with the first clause, wherein the configuration corresponds to a first configuration enabling an individual differentiated L2 procedure on top of at least one of default: packet data convergence protocol (PDCP) configuration, radio link control (RLC) configuration, or logical channel configuration.

Clause 13: The method alone or in combination with the first clause, wherein the configuration corresponds to a second configuration indicating a separate default packet data convergence protocol (PDCP) configuration, a radio link control (RLC) configuration, or a logical channel configuration for the at least one QPI.

Clause 14: The method alone or in combination with the first clause, wherein: the configuration indicates applying a first configuration and a second configuration to different protocol stock layers; the first configuration enabling an individual differentiated L2 procedure on top of at least one of default: packet data convergence protocol (PDCP) configuration, radio link control (RLC) configuration, or logical channel configuration; and the second configuration indicating a separate PDCP configuration, the RLC configuration, or the logical channel configuration for the at least one QPI.

Clause 15: The method alone or in combination with the first clause, wherein the at least one QPI has associated sequence numbers, when an inter-QPI out of order delivery is configured, based on the received configuration.

Clause 16: An apparatus, comprising: a memory comprising executable instructions; and a processor configured to execute the executable instructions and cause the apparatus to perform a method in accordance with any one of Clauses 1-15.

Clause 17: An apparatus, comprising means for performing a method in accordance with any one of Clauses 1-15.

Clause 18: A non-transitory computer-readable medium comprising executable instructions that, when executed by a processor of an apparatus, cause the apparatus to perform a method in accordance with any one of Clauses 1-15.

Clause 19: A computer program product embodied on a computer-readable storage medium comprising code for performing a method in accordance with any one of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications by a user equipment (UE), comprising:
receiving a configuration of at least one quality of service (QoS) profile identifier (QPI) from a network entity, wherein the at least one QPI is associated with a plurality of QoS flows within a data radio bearer (DRB), and wherein each of the plurality of QoS flows is associated with at least one protocol data unit (PDU); and
performing one or more layer 2 (L2) procedures, based on the received configuration.

2. The method of claim 1, wherein the configuration further indicates a mapping of one or more of the plurality of QoS flows within the DRB to the at least one QPI.

3. The method of claim 2, wherein the mapping is performed at a service data adaption protocol (SDAP) layer.

4. The method of claim 1, wherein the performing further comprises using separate discard timers for different PDUs associated with different QPIs.

5. The method of claim 1, wherein the performing further comprises allowing out of order delivery for different PDUs associated with different QPIs while applying in-order delivery for other PDUs associated with a same QPI.

6. The method of claim 1, wherein the performing further comprises using separate reordering timers for different PDUs associated with different QPIs.

7. The method of claim 1, wherein the performing further comprises allowing different primary paths for different PDUs associated with different QPIs.

8. The method of claim 1, wherein the performing further comprises applying duplication only on one or more PDUs associated with the at least one QPI.

9. The method of claim 1, wherein the performing further comprises using separate reassembly timers for different PDUs associated with different QPIs.

10. The method of claim 1, wherein the performing further comprises using separate status prohibit timers for different PDUs associated with different QPIs.

11. The method of claim 1, wherein the performing further comprises performing a separate set of prioritized bit rate (PBR), bucket size duration (BSD) and logical channel prioritization (LCP) restrictions for different PDUs associated with different QPIs.

12. The method of claim 1, wherein the configuration corresponds to a first configuration enabling an individual differentiated L2 procedure on top of at least one of default: packet data convergence protocol (PDCP) configuration, radio link control (RLC) configuration, or logical channel configuration.

13. The method of claim 1, wherein the configuration corresponds to a second configuration indicating a separate default packet data convergence protocol (PDCP) configuration, a radio link control (RLC) configuration, or a logical channel configuration for the at least one QPI.

14. The method of claim 1, wherein:
the configuration indicates applying a first configuration and a second configuration to different protocol stock layers;
the first configuration enabling an individual differentiated L2 procedure on top of at least one of default: packet data convergence protocol (PDCP) configuration, radio link control (RLC) configuration, or logical channel configuration; and
the second configuration indicating a separate PDCP configuration, the RLC configuration, or the logical channel configuration for the at least one QPI.

15. The method of claim 1, wherein the at least one QPI has associated sequence numbers, when an inter-QPI out of order delivery is configured, based on the received configuration.

16. A user equipment (UE) configured for wireless communications, comprising:
a memory comprising computer-executable instructions; and
a processor configured to execute the computer-executable instructions and cause the UE to:
receive a configuration of at least one quality of service (QoS) profile identifier (QPI) from a network entity, wherein the at least one QPI is associated with a plurality of QoS flows within a data radio bearer (DRB), and wherein each of the plurality of QoS flows is associated with at least one protocol data unit (PDU); and
perform one or more layer 2 (L2) procedures, based on the received configuration.

17. The UE of claim 16, wherein the configuration further indicates a mapping of one or more of the plurality of QoS flows within the DRB to the at least one QPI.

18. The UE of claim 17, wherein the mapping is performed at a service data adaption protocol (SDAP) layer.

19. The UE of claim 16, wherein the perform further comprises use separate discard timers for different PDUs associated with different QPIs.

20. The UE of claim 16, wherein the perform further comprises allow out of order delivery for different PDUs associated with different QPIs while applying in-order delivery for other PDUs associated with a same QPI.

21. The UE of claim 16, wherein the perform further comprises use separate reordering timers for different PDUs associated with different QPIs.

22. The UE of claim 16, wherein the perform further comprises allow different primary paths for different PDUs associated with different QPIs.

23. The UE of claim 16, wherein the perform further comprises apply duplication only on one or more PDUs associated with the at least one QPI.

24. The UE of claim 16, wherein the perform further comprises use separate reassembly timers for different PDUs associated with different QPIs.

25. The UE of claim 16, wherein the perform further comprises use separate status prohibit timers for different PDUs associated with different QPIs.

26. The UE of claim 16, wherein the perform further comprises perform a separate set of prioritized bit rate (PBR), bucket size duration (BSD) and logical channel prioritization (LCP) restrictions for different PDUs associated with different QPIs.

27. The UE of claim 16, wherein the configuration corresponds to a first configuration enabling an individual differentiated L2 procedure on top of at least one of default: packet data convergence protocol (PDCP) configuration, radio link control (RLC) configuration, or logical channel configuration.

28. The UE of claim 16, wherein the configuration corresponds to a second configuration indicating a separate default packet data convergence protocol (PDCP) configuration, a radio link control (RLC) configuration, or a logical channel configuration for the at least one QPI.

29. The UE of claim 16, wherein:
the configuration indicates applying a first configuration and a second configuration to different protocol stock layers;
the first configuration enabling an individual differentiated L2 procedure on top of at least one of default: packet data convergence protocol (PDCP) configuration, radio link control (RLC) configuration, or logical channel configuration; and
the second configuration indicating a separate PDCP configuration, the RLC configuration, or the logical channel configuration for the at least one QPI.

30. The UE of claim 16, wherein the at least one QPI has associated sequence numbers, when an inter-QPI out of order delivery is configured, based on the received configuration.
